(19) United States
(12) Patent Application Publication
(10) Pub. No.: US 2023/0417210 A1
(43) Pub. Date: Dec. 28, 2023

(54) IGNITION DEVICE FOR USE IN INTERNAL COMBUSTION ENGINE

(71) Applicant: Save The Planet Co., Ltd., Osaka (JP)

(72) Inventors: Mitsuhiro IZUMI, Osaka-shi (JP); Hiroyuki KIMURA, Osaka-shi (JP)

(21) Appl. No.: 18/175,827

(22) Filed: Feb. 28, 2023

(30) Foreign Application Priority Data
Jun. 23, 2022 (JP) 2022-101133

(51) Int. Cl. F02P 3/02; F02P 9/00; F02M 21/02

(52) U.S. Cl. CPC F02P 3/02; F02P 9/002; F02M 21/0215; F02M 21/0209

(57) ABSTRACT

An internal combustion engine ignition device includes; a transformer including a primary coil and a secondary coil that are electromagnetically coupled; an energization control unit that controls energization of the primary coil; a first spark plug electrically connected between a high-voltage terminal of the secondary coil and ground; and a second spark plug electrically connected between a low-voltage terminal of the secondary coil and the ground. The first spark plug and the second spark plug are placed in one same combustion chamber of an internal combustion engine. Thus, discharge occurs in the two spark plugs, so that a fuel can be more certainly ignited. Further, residual energy of the first spark plug and residual energy of the second spark plug offset each other, which enables rapid convergence of residual energy.

### RELATED APPLICATIONS

This application claims the benefit of Japanese Application No. 2022-101133, filed on Jun. 23, 2022, the disclosure of which is incorporated by reference herein.

### BACKGROUND OF THE INVENTION

### Field of the Invention

The present invention relates to an ignition device for use in an internal combustion engine.

### Description of the Background Art

In an ignition coil for use in an internal combustion engine, a current is caused to flow through a primary coil of a coil assembly, to generate a magnetic field. Then, the current is interrupted, so that a high voltage is generated in a secondary coil by the effect of self-induction. Due to the high voltage generated in the secondary coil at that time, discharge is performed in a spark plug.

A conventional ignition device for use in an internal combustion engine is described in Japanese Patent Application Laid-Open No. 2016-82193, for example. FIG. 4 shows a schematic circuit diagram of a conventional internal combustion engine ignition device 1X that is similar to the ignition device for use in an internal combustion engine described in Japanese Patent Application Laid-Open No. 2016-82193. Further, FIG. 5 shows an example of a potential difference (secondary voltage) between both ends of a secondary coil of the internal combustion engine ignition device 1X.

In the conventional internal combustion engine ignition device 1X as shown in FIGS. 4 and 5, an igniter Ig is turned on, and a voltage is supplied from a power supply Ba to a primary coil Co1 (energization period T1). After a voltage is supplied to the primary coil Co1 for a predetermined period of time, the igniter Ig is turned off. Then, by the effect of self-induction, a high voltage in a direction opposite to that in the energization period T1 is generated in a secondary coil Co2, and discharge occurs in a spark plug Pg (discharge period T2).

During the discharge, electric charge is stored in a capacitive component around the spark plug Pg. Thus, due to residual energy at that time, in a standby period T3 after the discharge, there arises a problem of taking time for the secondary voltage to converge as shown in FIG. 5.

Further, in recent years, use of hydrogen that is more combustible than conventional fuels and a flame-retardant fuel that is less combustible than conventional fuels, such as ammonia, is under consideration. There is a demand for a technique that can ensure ignition also in a case where a mixture of plural kinds of fuels different in readiness for ignition and combustion rate is used.

### SUMMARY OF THE INVENTION

It is an object of the present invention to provide a technique that allows a fuel to be more certainly ignited and enables rapid convergence of residual energy.

To solve the above-described problem, according to the first invention of the present application, an internal combustion engine ignition device includes: a transformer including a primary coil and a secondary coil that are electromagnetically coupled; an energization control unit that controls energization of the primary coil; a first spark plug electrically connected between a high-voltage terminal of the secondary coil and ground; and a second spark plug electrically connected between a low-voltage terminal of the secondary coil and the ground, wherein the first spark plug and the second spark plug are placed in one same combustion chamber of an internal combustion engine.

According to the second invention of the present application, in the internal combustion engine ignition device according to the first invention, a fuel gas introduced into the combustion chamber is a gas mixture in which plural kinds of fuels are mixed.

According to the third invention of the present application, in the internal combustion engine ignition device according to the second invention, the fuel gas introduced into the combustion chamber includes hydrogen.

According to the fourth invention of the present application, in the internal combustion engine ignition device according to the second or third invention, the fuel gas introduced into the combustion chamber includes a flame-retardant fuel.

According to the fifth invention of the present application, in the internal combustion engine ignition device according to the fourth invention, the flame-retardant fuel is ammonia.

According to the sixth invention of the present application, an internal combustion engine ignition device includes: a transformer including a primary coil and two secondary coils that are electromagnetically coupled; an energization control unit that controls energization of the primary coil; a first spark plug electrically connected between a high-voltage terminal of one of the secondary coils and ground; a second spark plug electrically connected between a low-voltage terminal of the one of the secondary coils and the ground; a third spark plug electrically connected between a high-voltage terminal of the other of the secondary coils and the ground; and a fourth spark plug electrically connected between a low-voltage terminal of the other of the secondary coils and the ground, wherein the first spark plug, the second spark plug, the third spark plug, and the fourth spark plug are placed in one same combustion chamber of an internal combustion engine.

The first to sixth inventions of the present application allow a fuel to be certainly ignited and enable rapid convergence of residual energy.

The second to fifth inventions of the present application are especially useful because there is a need to more certainly ignite a fuel.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram of an internal combustion engine ignition device according to a first preferred embodiment;

FIG. 2 is a view showing an example of a secondary voltage waveform in the internal combustion engine ignition device according to the first preferred embodiment;

FIG. 3 is a circuit diagram of an internal combustion engine ignition device according to a second preferred embodiment;

FIG. 4 is a circuit diagram of a conventional internal combustion engine ignition device; and

FIG. 5 is a view showing an example of a secondary voltage waveform in the conventional internal combustion engine ignition device.

### DESCRIPTION OF THE PREFERRED EMBODIMENTS

Hereinafter, illustrative preferred embodiments of the present invention will be described with reference to the drawings.

### 1. First Preferred Embodiment

<1-1. Configuration of Internal Combustion Engine Ignition Device>

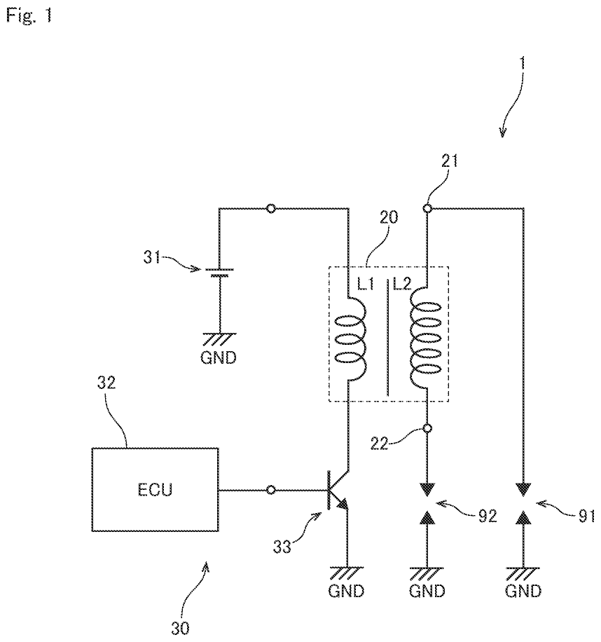

A configuration of an internal combustion engine ignition device 1 corresponding to one preferred embodiment of the present invention will be described with reference to the drawings. FIG. 1 is a circuit diagram of the internal combustion engine ignition device 1 according to a first preferred embodiment. Note that, in FIG. 1, details of a circuit on a primary side are omitted.

The internal combustion engine ignition device 1 according to the present embodiment is, for example, a device that is mounted in a body of a vehicle such as an automobile and applies a high voltage for causing spark discharge in spark plugs 91 and 92 for an internal combustion engine. As shown in FIG. 1, the internal combustion engine ignition device 1 includes a transformer 20, an energization control unit 30, a first spark plug 91, and a second spark plug 92.

In a case in which the internal combustion engine ignition device 1 is used in an internal combustion engine having a plurality of cylinders, a battery 31 and an engine control unit (ECU) 32 of the energization control unit 30 described later may be used in common by the plurality of cylinders. Meanwhile, the transformer 20, and an igniter 33 of the energization control unit 30 described later, the first spark plug 91, and the second spark plug 92 are provided for each of the cylinders. For example, in a four-cylinder internal combustion engine, one battery 31, one ECU 32, and four sets each including the transformer 20, the igniter 33, the first spark plug 91, and the second spark plug 92, are provided.

In the internal combustion engine in which the internal combustion engine ignition device 1 according to the present embodiment is used, a combustion gas introduced into a combustion chamber of each cylinder is a gas mixture in which plural kinds of fuels are mixed. The gas mixture includes a hydrogen gas and ammonia that is a flame-retardant fuel, for example. A hydrogen gas is more readily ignited than conventional fuels such as gasoline, and its combustion rate is high. Meanwhile, an ammonia gas is less readily ignited than conventional fuels such as gasoline, and its combustion rate is low. Thus, in a case in which a combustion gas including a mixture of fuels different in readiness for ignition and combustion rate is used, the ignition device needs to more certainly perform an ignition operation and to cause residual energy around the spark plug to more rapidly converge, than a conventional ignition device.

The transformer 20 includes a primary coil L1 and a secondary coil L2 that are electromagnetically coupled. The number of turns of the secondary coil L2 is larger than that of the primary coil L1. The secondary coil L2 includes a high-voltage terminal 21 and a low-voltage terminal 22 at both ends thereof.

The energization control unit 30 controls energization of the primary coil L1. The energization control unit 30 includes the battery 31, the ECU 32, and the igniter 33.

The battery 31 is a power supply device (storage battery) that can perform charge and discharge with direct-current power. In the present embodiment, the battery 31 is electrically connected to the primary coil L1 of the transformer 20 and the igniter 33. The battery 31 supplies a direct-current voltage to the primary coil L1 of the transformer 20 and the igniter 33.

The ECU 32 is an existing computer that comprehensively controls operations and the like of a transmission and an air bag in a vehicle body. The ECU 32 outputs an ignition signal to the igniter 33 and controls the ON/OFF operation of the igniter 33.

The igniter 33 controls energization of the primary coil L1. The igniter 33 is a switching element such as an insulated-gate bipolar transistor (IGBT), for example. The igniter 33 is turned on/off in accordance with an ignition signal provided from the ECU 32, and controls energization of the primary coil L1.

The first spark plug 91 and the second spark plug 92 are placed in the combustion chamber of the internal combustion engine, and are devices for performing an ignition operation in the combustion chamber of the internal combustion engine. The first spark plug 91 and the second spark plug 92 have the same plug specification and the same plug gap. The first spark plug 91 and the second spark plug 92 are placed in the same combustion chamber while being spaced apart from each other.

The first spark plug 91 is electrically connected between the high-voltage terminal 21 of the secondary coil L2 of the transformer 20 and the ground. In other words, one end of the first spark plug 91 is connected to the high-voltage terminal 21, and the other end of the first spark plug 91 is grounded.

The second spark plug 92 is electrically connected between the low-voltage terminal 22 of the secondary coil L2 of the transformer 20 and the ground. In other words, one end of the second spark plug 92 is connected to the low-voltage terminal 22, and the other end of the second spark plug 92 is grounded.

When the igniter 33 is turned on in accordance with an ignition signal provided from the ECU 32, a voltage is applied across both ends of the primary coil L1, so that a current is generated in the circuit on the primary side. Then, a magnetic flux is formed in the transformer 20. Thereafter, when the igniter 33 is turned off in accordance with an ignition signal provided from the ECU 32, electromagnetic induction is caused by the magnetic flux formed in the transformer 20, so that a high voltage in a direction opposite to the voltage supplied from the battery 31 is induced across both ends of the secondary coil L2. Thus, the high-voltage terminal 21 is at a largely minus potential with respect to the low-voltage terminal 22.

Consequently, the high-voltage terminal 21 connected to the first spark plug 91 is at a minus potential having a large absolute value, and the low-voltage terminal 22 connected to the second spark plug 92 is at a plus potential having a large absolute value. Thus, discharge occurs in the gaps of the first spark plug 91 and the second spark plug 92, so that spark occurs. As a result, a fuel supplied to the internal combustion engine is ignited.

<1-2. Change in Secondary-Side Voltage in Internal Combustion Engine Ignition Device>

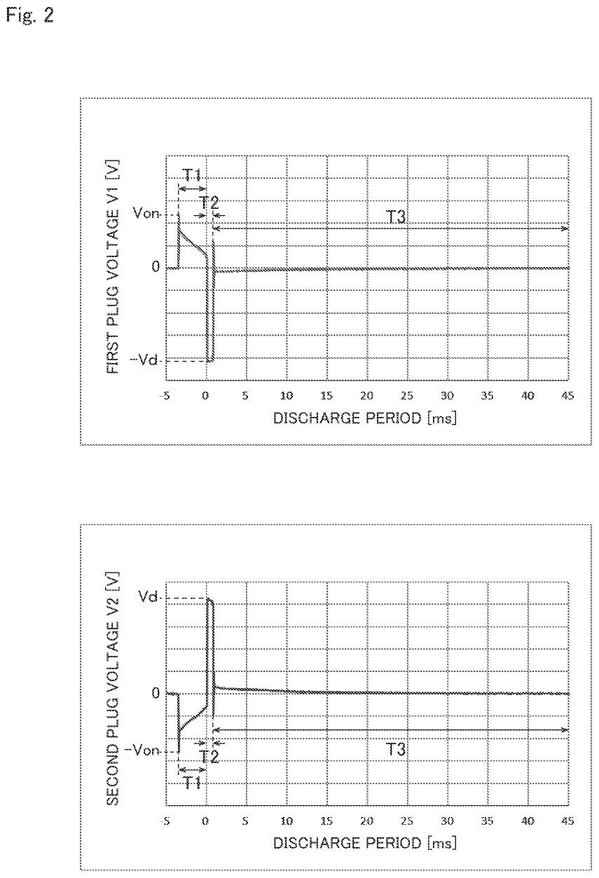

Next, with reference to FIG. 2, a change in a voltage on a secondary side in the internal combustion engine ignition device 1 according to the present embodiment will be described. FIG. 2 is a view showing an example of a secondary voltage waveform in the internal combustion engine ignition device 1 according to the present embodiment. Specifically, FIG. 2 shows results of simulation concerning the internal combustion engine ignition device 1. In the following description, a voltage at the high-voltage terminal 21 of the secondary coil L2 and a voltage at the low-voltage terminal 22 of the secondary coil L2 each of which corresponds to a secondary voltage will be referred to as a first plug voltage V1 and a second plug voltage V2, respectively.

In the internal combustion engine, an intake valve and an exhaust valve are opened and closed and the spark plugs are discharged in accordance with rotation of a crank shaft, so that a cycle of intake, compression, combustion, and exhaust is performed. The internal combustion engine ignition device 1 discharges the spark plugs near the compression top dead center, to cause a compressed fuel gas in the combustion chamber to burn. To discharge the spark plugs 91 and 92, the internal combustion engine ignition device 1 energizes the primary coil L1 (energization period T1), discharges the spark plugs 91 and 92 (discharge period T2), and collects residual energy (standby period T3) in accordance with movement of a piston.

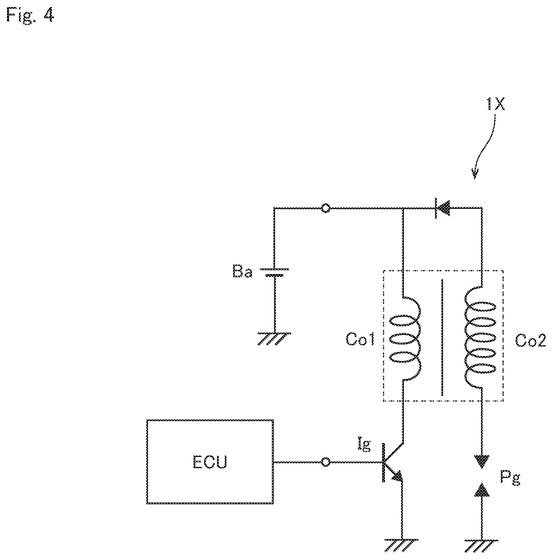

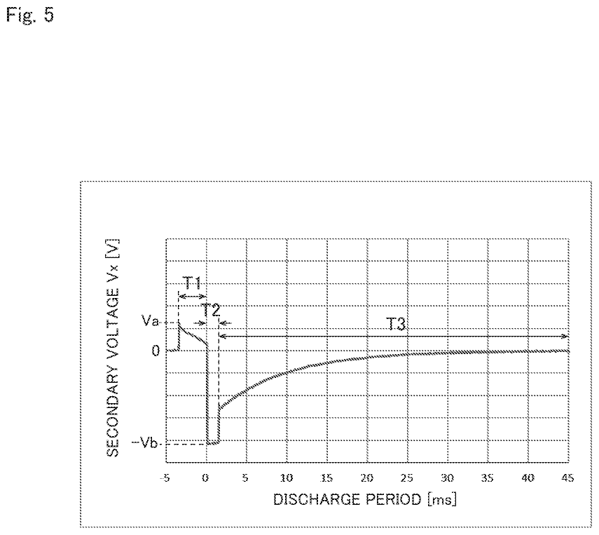

Here, a change in a secondary voltage Vx in the conventional internal combustion engine ignition device 1X shown in FIG. 4 will be described, first, with reference to FIG. 5. In the internal combustion engine ignition device 1X, the spark plug Pg is connected between a high-voltage terminal of the secondary coil Co2 and the ground. In the following description, a voltage at the high-voltage terminal of the secondary coil Co2 will be referred to as a secondary voltage Vx. That is, the secondary voltage Vx is a voltage applied across both ends of the spark plug Pg. Immediately after the internal combustion engine ignition device 1X starts being used, in other words, before the energization period T1, the secondary voltage Vx is 0 [V].

When the energization period T1 starts and the primary coil Co1 starts being energized, a voltage (ON-state voltage, Va [V] in FIG. 5) is generated in the secondary coil Co2 as a voltage is supplied to the primary coil Co1. While the primary coil Co1 is kept being energized, a magnetic flux is formed in the transformer, which causes the secondary voltage Vx to gradually decrease from the ON-state voltage.

When the energization period T1 ends and supply of power to the primary coil Co1 is interrupted, a high voltage in a direction opposite (minus) to the ON-state voltage is generated in the secondary coil Co2. As a result, a high voltage (−Vb [V] in FIG. 5) is applied to the spark plug Pg, and discharge occurs in the gap of the spark plug Pg (discharge period T2). Thereafter, the magnetic flux formed in a transformer is weakened by the discharge, and hence the absolute value of a secondary current (a current flowing through the secondary coil Co2 and the spark plug Pg) gradually decreases. Then, the discharge in the spark plug Pg ends.

In the discharge period T2, due to flow of a current through the spark plug Pg, electric charge is stored in a capacitive component around the spark plug Pg. Specifically, positive electric charge is stored on the ground side of the spark plug Pg, and negative electric charge is stored on the side closer to the secondary coil Co2.

Thus, in the standby period T3, the secondary voltage Vx is kept at a minus potential for a while due to the residual energy stored in the parasitic capacitance around the spark plug Pg. The secondary voltage Vx converges to 0 [V] as the residual energy converges.

Next, a change in the first plug voltage V1 and the second plug voltage V2 in the internal combustion engine ignition device 1 according to the present embodiment will be described with reference to FIG. 2.

First, immediately after the internal combustion engine ignition device 1 starts being used, in other words, before the energization period T1, no electric charge is stored in the secondary coil L2, the first spark plug 91, and the second spark plug 92, and thus all the potentials thereof in the circuit are 0 [V]. Specifically, both of the first plug voltage V1 and the second plug voltage V2 are 0 [V].

When the energization period T1 starts and the primary coil L1 starts being energized, a potential difference is caused between both ends of the secondary coil L2 as a voltage is supplied to the primary coil L1. Here, suppose that a voltage generated in the secondary coil L2 immediately after the start of energization is 2*Von [V]. Then, the first plug voltage V1 becomes equal to Von [V] and the second plug voltage V2 becomes equal to −Von [V] because the other end of the first spark plug 91 and the other end of the second spark plug 92 are grounded to 0 [V]. Such a voltage generated at the start of the energization period T1 is referred to as an ON-state voltage.

While the primary coil L1 is kept being energized, a potential difference between both ends of the secondary coil L2 gradually decreases from 2*Von [V] as a magnetic flux is formed in the transformer 20. This causes also the absolute values of the first plug voltage V1 and the second plug voltage V2 to gradually decrease from Von [V].

When the energization period T1 ends and supply of power to the primary coil L1 is interrupted, a high voltage in a direction opposite to the ON-state voltage is generated in the secondary coil L2. As a result, a high minus voltage is applied to the first spark plug 91, so that discharge occurs in the gap of the first spark plug 91. Further, a high plus voltage is applied to the second spark plug 92, so that discharge occurs in the gap of the second spark plug 92 (discharge period T2).

Here, suppose that a value of the maximum voltage generated in the secondary coil L2 in the discharge period T2 is −2*Vd [V]. Thus, at the start of the discharge period T2, the first plug voltage V1 is equal to −Vd [V], and the second plug voltage V2 is equal to Vd [V].

In the discharge period T2, a current flows through the first spark plug 91 and the second spark plug 92, so that electric charge is stored in a capacitive component around the first spark plug 91 and in a capacitive component around the second spark plug 92. More specifically, in the first spark plug 91, positive electric charge is stored on the other-end side (ground side), and negative electric charge is stored on the one-end side (the side closer to the high-voltage terminal 21). Meanwhile, in the second spark plug 92, negative electric charge is stored on the other-end side (ground side), and positive electric charge is stored on the one-end side (the side closer to the low-voltage terminal 22).

When the discharge period T2 ends and the standby period T3 starts, the electric charge moves such that the electric charge stored in the capacitive component around the first spark plug 91 and the electric charge stored in the capacitive component around the second spark plug 92 negate each other. This results in dissipation of both of residual energy stored in the parasitic capacitance around the first spark plug 91 and residual energy stored in the parasitic capacitance around the second spark plug 92.

As described above, the first spark plug 91 and the second spark plug 92 have the same plug specification and the same plug gap. Hence, the electrical conditions of the first spark plug 91 and the second spark plug 92 are the same with each other. Thus, the residual energy stored in the parasitic capacitance around the first spark plug 91 is substantially equal to the residual energy stored in the parasitic capacitance around the second spark plug 92. This allows the residual energy around the first spark plug 91 and the residual energy around the second spark plug 92 to well-balancedly offset each other.

Note that, due to transfer of the electric charge between the parasitic capacitance around the first spark plug 91 and the parasitic capacitance around the second spark plug 92, a current temporarily flows through the secondary coil L2, and the first plug voltage V1 and the second plug voltage V2 temporarily oscillate.

As a result of the above-described transfer of the electric charge, the most part of the residual energy stored in the parasitic capacitance around the first spark plug 91 and the most part of the residual energy stored in the parasitic capacitance around the second spark plug 92 are both eliminated, and very little energy is left immediately after the end of the discharge period T2. Then, due to the residual energy having been left, the first plug voltage V1 is at a relatively slightly minus potential, and the second plug voltage V2 is at a relatively slightly plus potential. Thereafter, both of the first plug voltage V1 and the second plug voltage V2 converge to 0 [V].

In a case in which only one spark plug is provided, like that in the conventional internal combustion engine ignition device 1X shown in FIGS. 4 and 5, a lot of residual energy is left also in the standby period T3. In contrast thereto, in the internal combustion engine ignition device 1 according to the present embodiment, the single secondary coil L2 is connected to the two spark plugs 91 and 92, which allows the residual energy to rapidly converge.

In the meantime, there is conventionally known a distributor less ignition with double ended coil (D-DLI) system having a circuit configuration similar to that of the internal combustion engine ignition device 1 according to the present embodiment. In the D-DLI system, the first spark plug 91 and the second spark plug 92 are placed in respective combustion chambers of two cylinders having a difference of half cycle. In other words, the second spark plug 92 is placed in the back cylinder of the cylinder in which the first spark plug 91 is placed.

Thus, when discharge is caused near the compression top dead center in the first spark plug 91, discharge is caused near the exhaust top dead center in the second spark plug 92. At that time, near the compression top dead center, a pressure in the combustion chamber is high, and hence a voltage required to discharge the first spark plug 91 is high, resulting in much residual energy after the discharge. Meanwhile, near the exhaust top dead center, a pressure in the combustion chamber is low, and hence a voltage required to discharge the second spark plug 92 is low, resulting in little residual energy after the discharge.

Consequently, even though the residual energy in the parasitic capacitance around the first spark plug 91 and the residual energy in the parasitic capacitance around the second spark plug 92 offset each other after the discharge, the residual energy around the first spark plug 91 is still left to a certain degree, causing a problem.

In contrast thereto, in the internal combustion engine ignition device 1 according to the present embodiment, connecting the single secondary coil L2 to the two spark plugs 91 and 92 enables rapid convergence of residual energy.

Further, in the internal combustion engine ignition device 1 according to the present embodiment, both of the first spark plug 91 and the second spark plug 92 are placed in the same combustion chamber. Thus, in the combustion chamber, discharge occurs in two places at the same time. Therefore, a fuel can be more certainly ignited also in a case in which a mixture of plural kinds of fuels different in readiness for ignition and combustion rate is used as the fuel. This enables use of a fuel mixture including hydrogen that is more combustible than conventional fuels and a flame-retardant fuel that is less combustible than conventional fuels, such as ammonia.

### 2. Second Preferred Embodiment

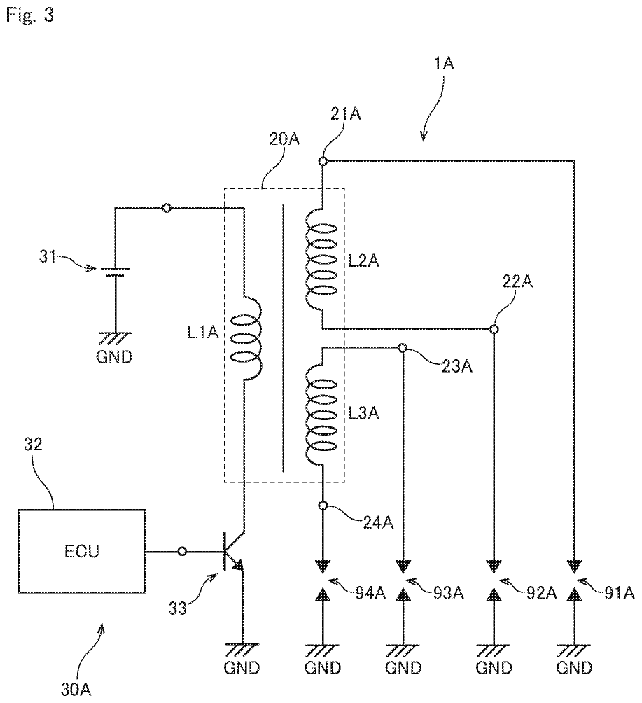

Next, a configuration of an internal combustion engine ignition device 1A corresponding to a second preferred embodiment of the present invention will be described with reference to the drawings. FIG. 3 is a circuit diagram of the internal combustion engine ignition device 1A according to the second preferred embodiment.

As shown in FIG. 3, the internal combustion engine ignition device 1A includes a transformer 20A, an energization control unit 30A, a first spark plug 91A, a second spark plug 92A, a third spark plug 93A, and a fourth spark plug 94A. The energization control unit 30A is similar to the energization control unit 30 according to the first preferred embodiment, and hence description thereof is omitted.

The transformer 20A includes a primary coil L1A, a first secondary coil L2A, and a second secondary coil L3A that are electromagnetically coupled. The first secondary coil L2A and the second secondary coil L3A have each the number of turns larger than that of the primary coil L1A. The first secondary coil L2A includes a first high-voltage terminal 21A and a first low-voltage terminal 22A at both ends thereof. The second secondary coil L3A includes a second high-voltage terminal 23A and a second low-voltage terminal 24A at both ends thereof.

The first spark plug 91A, the second spark plug 92A, the third spark plug 93A, and the fourth spark plug 94A are placed in a combustion chamber of an internal combustion engine and are devices for performing an ignition operation in the combustion chamber of the internal combustion engine. The first spark plug 91A and the second spark plug 92A have the same plug specification and the same plug gap. Meanwhile, the third spark plug 93A and the fourth spark plug 94A have the same plug specification and the same plug gap. The first spark plug 91A, the second spark plug 92A, the third spark plug 93A, and the fourth spark plug 94A are placed in the same combustion chamber while being spaced apart from each other.

The first spark plug 91A is electrically connected between the first high-voltage terminal 21A of the first secondary coil L2A of the transformer 20A and the ground. Specifically, one end of the first spark plug 91A is connected to the first high-voltage terminal 21A, and the other end of the first spark plug 91A is grounded.

The second spark plug 92A is electrically connected between the first low-voltage terminal 22A of the first secondary coil L2A of the transformer 20A and the ground. Specifically, one end of the second spark plug 92A is connected to the first low-voltage terminal 22A, and the other end of the second spark plug 92A is grounded.

The third spark plug 93A is electrically connected between the second high-voltage terminal 23A of the second secondary coil L3A of the transformer 20A and the ground. Specifically, one end of the third spark plug 93A is connected to the second high-voltage terminal 23A, and the other end of the third spark plug 93A is grounded.

The fourth spark plug 94A is electrically connected between the second low-voltage terminal 24A of the second secondary coil L3A of the transformer 20A and the ground. Specifically, one end of the fourth spark plug 94A is connected to the second low-voltage terminal 24A, and the other end of the fourth spark plug 94A is grounded.

When the igniter 33 is turned on in accordance with an ignition signal provided from the ECU 32, a voltage is applied across both ends of the primary coil L1A, so that a current is generated in the circuit on the primary side. As a result, a magnetic flux is formed in the transformer 20A. Thereafter, when the igniter 33 is turned off in accordance with an ignition signal provided form the ECU 32, electromagnetic induction is caused by the magnetic flux formed in the transformer 20A, so that a high voltage in a direction opposite to the voltage supplied from the battery 31 is induced across both ends of each of the first secondary coil L2A and the second secondary coil L3A. Thus, the first high-voltage terminal 21A is at a largely minus potential with respect to the first low-voltage terminal 22A, and the second high-voltage terminal 23A is at a largely minus potential with respect to the second low-voltage terminal 24A.

Consequently, the first high-voltage terminal 21A connected to the first spark plug 91A is at a minus potential having a large absolute value, and the first low-voltage terminal 22A connected to the second spark plug 92A is at a plus potential having a large absolute value. Thus, discharge occurs in the gaps of the first spark plug 91A and the second spark plug 92A, so that spark occurs. As a result, a fuel supplied to the internal combustion engine is ignited.

At the same time, the second high-voltage terminal 23A connected to the third spark plug 93A is at a minus potential having a large absolute value, and the second low-voltage terminal 24A connected to the fourth spark plug 94A is at a plus potential having a large absolute value. Thus, discharge occurs in the gaps of the third spark plug 93A and the fourth spark plug 94A, so that spark occurs. As a result, a fuel supplied to the internal combustion engine is ignited.

In the internal combustion engine ignition device 1A described above, when the discharge period T2 ends and the standby period T3 starts, electric charge moves such that electric charge stored in a capacitive component around the first spark plug 91A and electric charge stored in a capacitive component around the second spark plug 92A negate each other. This results in dissipation of both of residual energy stored in the parasitic capacitance around the first spark plug 91A and residual energy stored in the parasitic capacitance around the second spark plug 92A.

Further, when the discharge period T2 ends and the standby period T3 starts, electric charge moves such that electric charge stored in a capacitive component around the third spark plug 93A and electric charge stored in a capacitive component around the fourth spark plug 94A negate each other. This results in dissipation of both of residual energy stored in the parasitic capacitance around the third spark plug 93A and residual energy stored in the parasitic capacitance around the fourth spark plug 94A.

As described above, the first spark plug 91A and the second spark plug 92A have the same plug specification and the same plug gap. Hence, the residual energy stored in the parasitic capacitance around the first spark plug 91A is substantially equal to the residual energy stored in the parasitic capacitance around the second spark plug 92A. This allows the residual energy around the first spark plug 91A and the residual energy around the second spark plug 92A to well-balancedly offset each other.

Further, the third spark plug 93A and the fourth spark plug 94A have the same plug specification and the same plug gap. Hence, the residual energy stored in the parasitic capacitance around the third spark plug 93A is substantially equal to the residual energy stored in the parasitic capacitance around the fourth spark plug 94A. This allows the residual energy around the third spark plug 93A and the residual energy around the fourth spark plug 94A to well-balancedly offset each other.

As a result of the above-described transfer of the electric charge, the most part of the residual energy stored in the parasitic capacitance around each of the four spark plugs 91A, 92A, 93A, and 94A is eliminated, and very little energy is left immediately after the end of the discharge period T2. Specifically, in the internal combustion engine ignition device 1A according to the present embodiment, the two spark plugs 91A and 92A are connected to the single first secondary coil L2A, and the two spark plugs 93A and 94A are connected to the single second secondary coil L3A, which allows the residual energy to rapidly converge for each of the spark plugs 91A, 92A, 93A, and 94A.

In the internal combustion engine ignition device 1A according to the present embodiment, more spark plugs 91A, 92A, 93A, and 94A are placed in the same combustion chamber than in the internal combustion engine ignition device 1 according to the first preferred embodiment. Thus, the number of discharge spots, in other words, the number of heat generating spots, is increased.

Consequently, ignition is more easily achieved in the combustion chamber. Thus, also in a case in which a mixture of plural kinds of fuels different in readiness for ignition and combustion rate is used, ignition can be more certainly achieved. This enables use of a fuel mixture including hydrogen that is more combustible than conventional fuels and a flame-retardant fuel that is less combustible than conventional fuels, such as ammonia. Especially, for use of a fuel mixture, ignition can be certainly achieved also in a case in which a mixture ratio is out of balance, depending on a position in the combustion chamber. Further, an increase in the number of heat generating spots can increase the combustion rate in the combustion chamber.

### 3. Modifications

The illustrative preferred embodiments of the present invention have been described above, but the present invention is not limited to the above-described preferred embodiments.

The internal combustion engine ignition device according to the present invention can be applied to any device that is mounted in various apparatuses such as a power generator or industrial machines, in addition to a vehicle such as an automobile, and is used for igniting a fuel by causing electric spark in a spark plug of an internal combustion engine.

The details of the shapes and configurations of the above-described internal combustion engine ignition devices may be appropriately changed within a scope not departing from the gist of the present invention. Further, the respective elements described in the above-described embodiments and modifications may be appropriately combined unless contradiction arises.

While the invention has been shown and described in detail, the foregoing description is in all aspects illustrative and not restrictive. It is therefore understood that numerous modifications and variations can be devised without departing from the scope of the invention.

What is claimed is:

1. An internal combustion engine ignition device comprising:
a transformer including a primary coil and a secondary coil that are electromagnetically coupled;
an energization control unit that controls energization of the primary coil;
a first spark plug electrically connected between a high-voltage terminal of the secondary coil and ground; and
a second spark plug electrically connected between a low-voltage terminal of the secondary coil and the ground, wherein
the first spark plug and the second spark plug are placed in one same combustion chamber of an internal combustion engine.

2. The internal combustion engine ignition device according to claim 1, wherein a fuel gas introduced into the combustion chamber is a gas mixture in which plural kinds of fuels are mixed.

3. The internal combustion engine ignition device according to claim 2, wherein the fuel gas introduced into the combustion chamber includes hydrogen.

4. The internal combustion engine ignition device according to claim 2, wherein the fuel gas introduced into the combustion chamber includes a flame-retardant fuel.

5. The internal combustion engine ignition device according to claim 4, wherein the flame-retardant fuel is ammonia.

6. An internal combustion engine ignition device comprising:
a transformer including a primary coil and two secondary coils that are electromagnetically coupled;
an energization control unit that controls energization of the primary coil;
a first spark plug electrically connected between a high-voltage terminal of one of the secondary coils and ground;
a second spark plug electrically connected between a low-voltage terminal of the one of the secondary coils and the ground;
a third spark plug electrically connected between a high-voltage terminal of the other of the secondary coils and the ground; and
a fourth spark plug electrically connected between a low-voltage terminal of the other of the secondary coils and the ground, wherein
the first spark plug, the second spark plug, the third spark plug, and the fourth spark plug are placed in one same combustion chamber of an internal combustion engine.
